(19) United States
(12) Patent Application Publication
(10) Pub. No.: US 2019/0064939 A1
(43) Pub. Date: Feb. 28, 2019

(54) MOUSE DEVICE

(71) Applicant: Primax Electronics Ltd., Taipei (TW)

(72) Inventors: LIANG ZHAO, Taipei (TW); DONG-XU SU, Taipei (TW)

(21) Appl. No.: 15/865,606

(22) Filed: Jan. 9, 2018

(30) Foreign Application Priority Data
Aug. 29, 2017 (CN) 201710757085.1

(51) Int. Cl. G06F 3/0354; G06F 3/039

(52) U.S. Cl. CPC G06F 3/03543; G06F 2203/0333; G06F 3/039

(57) ABSTRACT

The present invention provides a mouse device, including a housing, a telescopic portion, and a motor. The housing includes a base, an upper cover covering the base, and a through hole located between the upper cover and the base. The telescopic portion may move outward the housing through the through hole. The motor is disposed within the housing, and is configured to provide a power to the telescopic portion, so as to adjust a volume of the telescopic portion exposed outside the housing to support a hand portion of a user.

### FIELD OF THE INVENTION

The present invention relates to the field of input apparatuses, and in particular, to a mouse device.

### BACKGROUND OF THE INVENTION

Technologies develop rapidly, and the era of multimedia and computer has come. In a computer system, input apparatuses connecting computer hosts and users play a very important role. The input apparatuses include mouse devices, keyboard devices, trackball devices, and the like. The mouse device may be held in hands by a user to control a cursor of a mouse to move, and manipulated by fingers of the user to click on and select an image or perform a function, so that the mouse device becomes a most common input apparatus.

Under a trend of being simple, convenient, and light, a volume and a size of the mouse device are gradually decreased, thereby increasing portability and operability. However, sizes of hand portions of people are not completely the same, so a mouse device of a fixed volume and size cannot accurately meet requirements of each people. Consequently, the hand portions of some users cannot be effectively supported when operating the mouse device, causing discomfort to the users and reducing the working efficiency during long time use of the mouse device.

In view of this, for the moment, a mouse device that may deform according to a size of a hand portion of a user is provided, as disclosed in the US Patent Publication No. US2017/0192536 and the Taiwan Utility Patent Publication No. TWM336482. In both patents, a volume and a size of the mouse device are changed by rotating or moving outer components to enable the mouse device to deform. However, in structure design, a gap between the outer components of the deformable mouse device is relatively large, and an appearance of the mouse device is not flat. Consequently, a touch sense of the user for operating the mouse device is affected, and components within the mouse device cannot be protected neither. In addition, the mouse device only has two volumes and sizes for the user to select, that is, a volume and a size before the deformation and a volume and a size after the deformation leading to that the user cannot make a further fine adjustment, and requirements of the user obviously cannot be met. Therefore, the conventional mouse device may be improved.

### SUMMARY OF THE INVENTION

A main objective of the present invention is to provide a mouse device, and in particular, to a mouse device that may enable a user to steplessly adjust a volume and a size thereof while remaining flat in appearance.

In a preferred embodiment, the present invention provides a mouse device, including:

a housing, including a base and an upper cover, where the upper cover covers the base, and a through hole is formed between the upper cover and the base;

a telescopic portion, configured to support a hand portion of a user when at least a part of the telescopic portion is exposed outside the housing; and

a motor, disposed within the housing, and configured to provide a power to enable the telescopic portion to move outward or inward the housing through the through hole.

### BRIEF DESCRIPTION OF THE DRAWINGS

FIG. 1 is a conceptual schematic diagram that a mouse device is connected to a calculator device according to the present invention;

FIG. 2 is an external structural schematic diagram of a mouse device in a preferred embodiment according to the present invention;

FIG. 3 is an external structural schematic diagram of a housing of the mouse device shown in FIG. 2;

FIG. 4 is a partial three-dimensional exploded structural schematic diagram of the mouse device shown in FIG. 2;

FIG. 5 is a partial three-dimensional exploded structural schematic diagram of the mouse device shown in FIG. 2 from another angle of view;

FIG. 6 is a partial cross-sectional structural schematic diagram of a mouse device 1 shown in FIG. 2 in a first state;

FIG. 7 is a schematic structural diagram of a telescopic portion and a transmission module of a mouse device 1 shown in FIG. 2 in a first state;

FIG. 8 is a partial cross-sectional structural schematic diagram of the mouse device shown in FIG. 2 in a second state; and

FIG. 9 is a schematic structural diagram of the telescopic portion and the transmission module of the mouse device shown in FIG. 2 in a second state.

### DETAILED DESCRIPTION OF THE PREFERRED EMBODIMENT

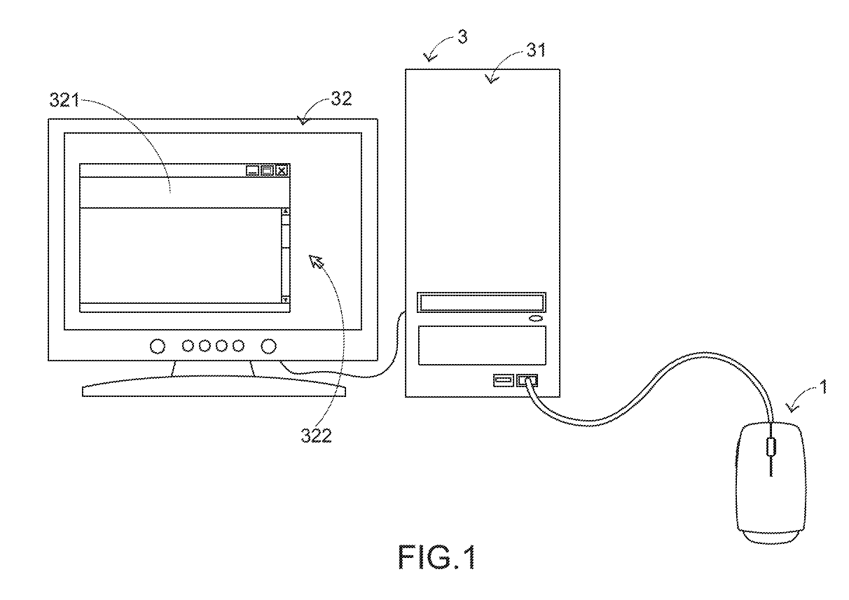

Referring to FIG. 1, FIG. 1 is a conceptual schematic diagram that a mouse device is connected to a calculator device according to the present invention. In this preferred embodiment, a calculator device 3 includes a computer host 31 and a computer screen 32. The computer host 31 is separately connected to a mouse device 1 and the computer screen 32. Although connection is achieved in a wired manner in FIG. 1, it is not limited thereto; and the connection may alternatively be achieved in a wireless manner Moreover, the computer screen 32 may display a cursor 322 and a window 321. The mouse device 1 is held and moved by a hand portion of a user. The computer host 31 further moves the cursor 322 in the computer screen 32 according to a displacement of the mouse device 1. However, the specific implementation and operation principle that the user controls the cursor 322 in the computer screen 32 to move by using the mouse device 1 are known by a person skilled in the art, and details are not described herein again.

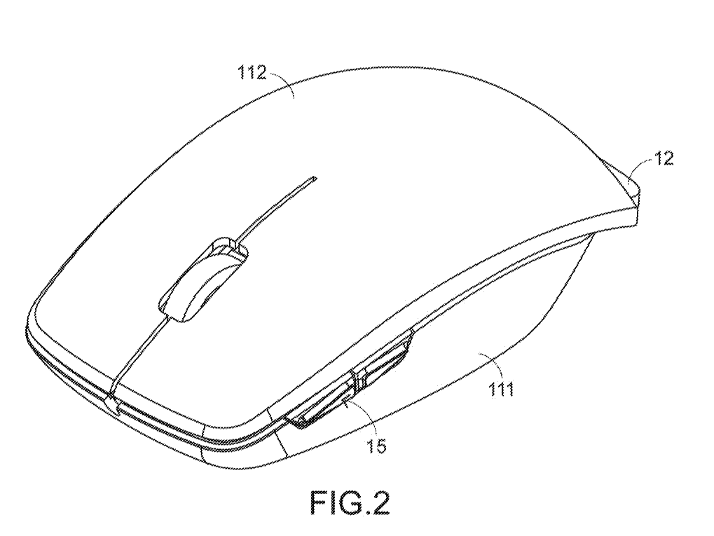

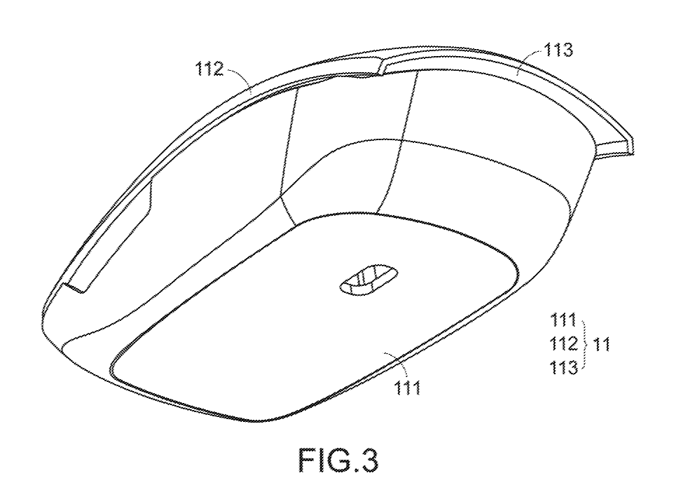

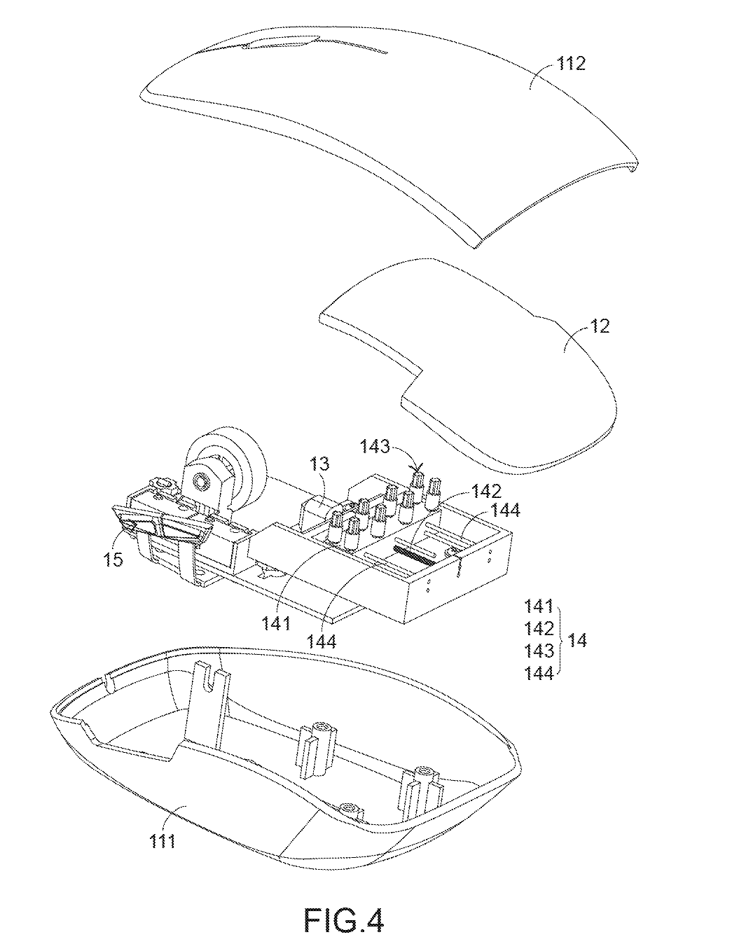

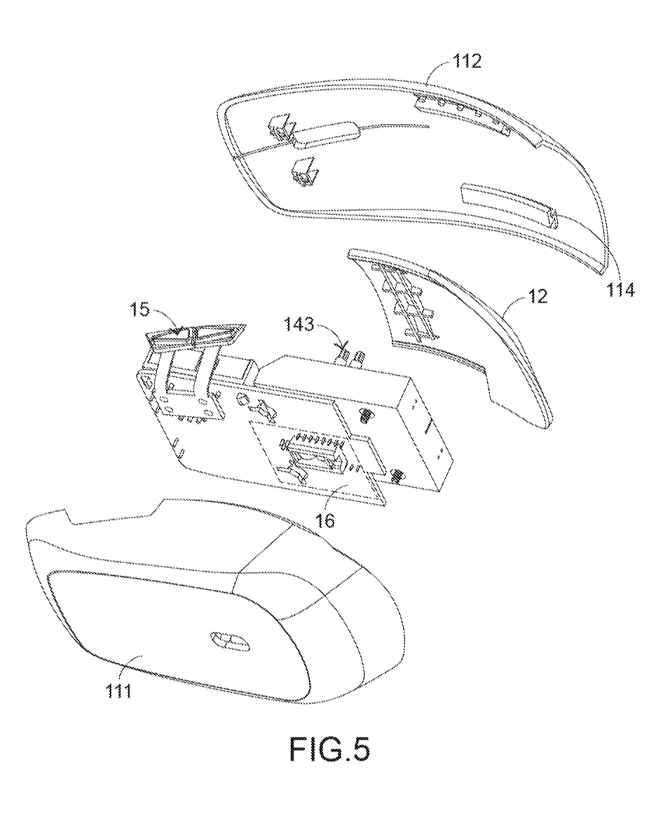

Referring to FIG. 2 to FIG. 5, FIG. 2 is an external structural schematic diagram of a mouse device in a preferred embodiment according to the present invention; FIG. 3 is an external structural schematic diagram of a housing of the mouse device shown in FIG. 2; FIG. 4 is a partial three-dimensional exploded structural schematic diagram of the mouse device shown in FIG. 2; and FIG. 5 is a partial three-dimensional exploded structural schematic diagram of the mouse device shown in FIG. 2 from another angle of view. A mouse device 1 includes a housing 11, a telescopic portion 12, a motor 13, and a transmission module 14. The housing 11 is held and moved by a hand portion of a user, and includes a base 111 and an upper cover 112 covering the base 111. Moreover, a through hole 113 is formed between the upper cover 112 and the base 111.

Further, the telescopic portion 12 is nested by the housing 11. The telescopic portion 12 may move outward the housing 11 through the through hole 113, so as to enable the mouse device 1 to extend; and may alternatively move inward the housing 11 through the through hole 113, so as to enable the mouse device 1 to contract. When the telescopic portion 12 moves outward the housing 11 to be exposed outside the housing 11, the telescopic portion 12 exposed outside the housing 11 may support the hand portion of a user. In addition, both the motor 13 and the transmission module 14 are disposed within the housing 11. The transmission module 14 is connected between the motor 13 and the telescopic portion 12, and is configured to transmit a power provided by the motor 13 to the telescopic portion 12, so as to move the telescopic portion 12.

In this preferred embodiment, the through hole 113 is located at a rear side of the housing 11, and the housing 11 further includes a sliding slot 114 disposed at an inner side of the upper cover 112, so that at least a part of the telescopic portion 12 is embedded in the sliding slot 114 and nests the telescopic portion 12. In this way, the telescopic portion 12 may slide along the sliding slot 114. Further, in this preferred embodiment, the transmission module 14 includes a pedestal 141, a guide screw rod 142, a damping portion 143, and a plurality of guide rods 144. The telescopic portion 12 is disposed on the pedestal 141. The damping portion 143 is located between the pedestal 141 and the telescopic portion 12. The guide screw rod 142 is connected to the motor 13, and passes through the pedestal 141 in a front-back direction. The plurality of guide rods 144 also separately pass through the pedestal 141 and are parallel to the guide screw rod 142. In addition, the damping portion 143 may be a single damper, or may be composed of a plurality of dampers.

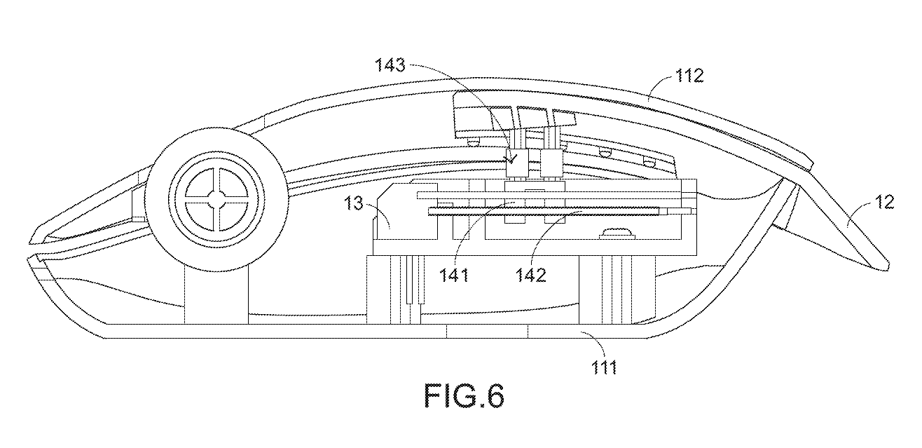

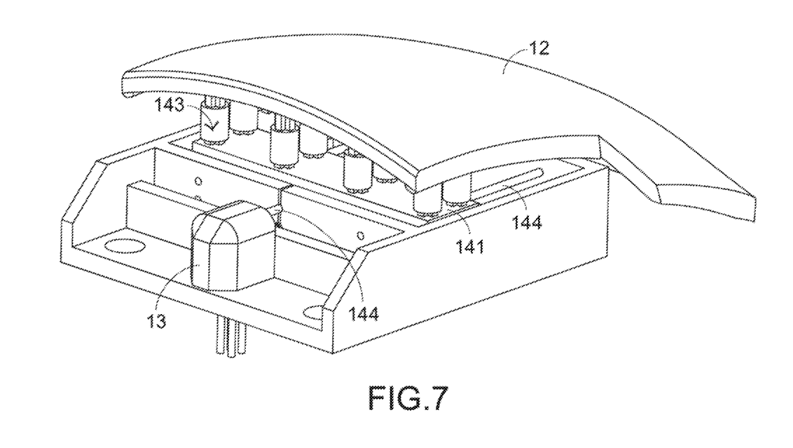

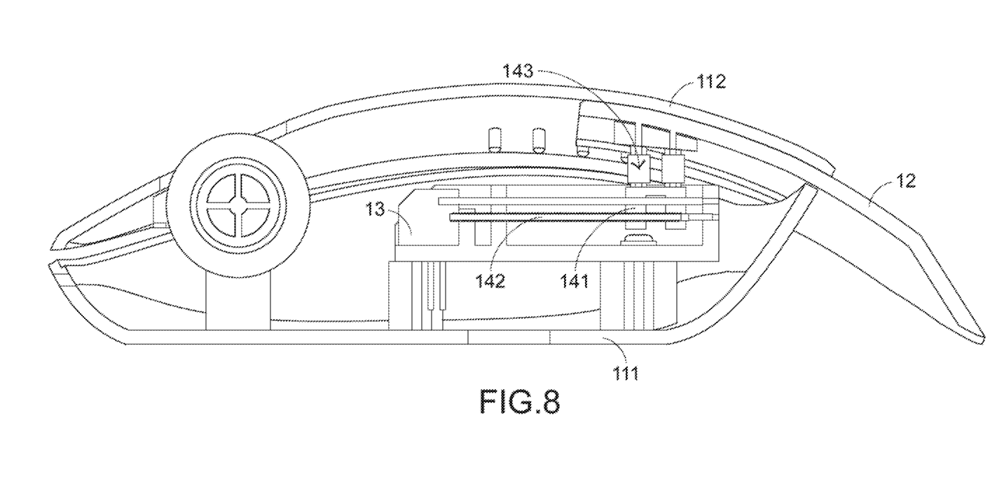

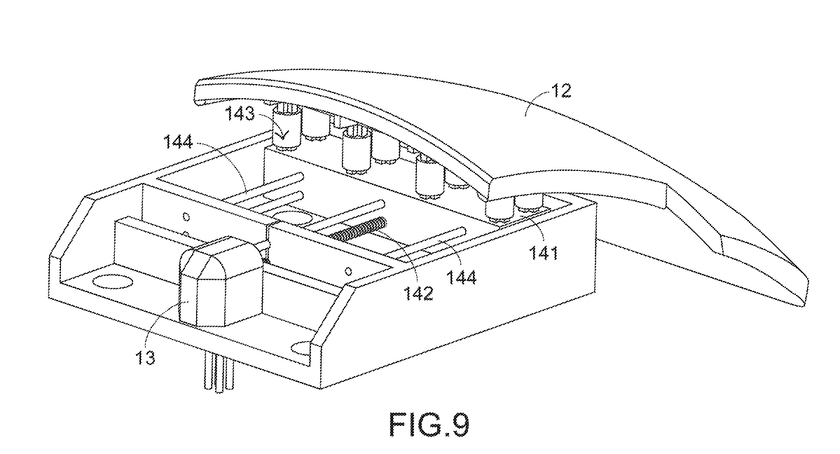

Extension and contraction operations of the mouse device 1 in the present invention are described in the following. Referring to FIG. 6 to FIG. 9, FIG. 6 is a partial cross-sectional structural schematic diagram of a mouse device 1 shown in FIG. 2 in a first state; FIG. 7 is a schematic structural diagram of a telescopic portion and a transmission module of the mouse device 1 shown in FIG. 2 in a first state; FIG. 8 is a partial cross-sectional structural schematic diagram of the mouse device shown in FIG. 2 in a second state; and FIG. 9 is a schematic structural diagram of the telescopic portion and the transmission module of the mouse device shown in FIG. 2 in a second state. In the first state shown in FIG. 6 and FIG. 7, the pedestal 141 of the mouse device 1 is located at a front side of the guide screw rod 142, and only a small part of the telescopic portion 12 is exposed outside the housing 11. However, after the motor 13 provides a power to enable the guide screw rod 142 to rotate in a positive direction, the pedestal 141 is driven by the guide screw rod 142 to move toward the rear side of the mouse device 1 along the guide screw rod 142 and the guide rod 144. Therefore, the damping portion 143 above and the telescopic portion 12 may be brought to the rear side of the mouse device 1 at the same time, so as to increase a volume of the telescopic portion 12 exposed outside the housing 11 to support the hand portion of the user, forming the second state shown in FIG. 8 and FIG. 9.

On the contrary, after the mouse device 1 is in the second state shown in FIG. 8 and FIG. 9 and the motor 13 provides a power to enable the guide screw rod 142 to rotate in a negative direction, the pedestal 141 is driven by the guide screw rod 142 to move toward the front side of the mouse device 1 along the guide screw rod 142 and the guide rod 144. As a result, the damping portion 143 above and the telescopic portion 12 are brought to the front side of the mouse device 1 at the same time, so as to decrease the volume of the telescopic portion 12 exposed outside the housing 11, forming the first state shown in FIG. 6 and FIG. 7.

It should also be noted that based on the ergonomics through which the hand portion operates the mouse device 1, both the upper cover 112 and the telescopic portion 12 of the mouse device 1 have structures having curved surfaces. Therefore, it is a curvilinear motion for the telescopic portion 12 to move outward the housing 11 or inward the housing 11. However, reciprocation performed by the pedestal 141 because of being driven by the guide screw rod 142 in response to the power provided by the motor 13 is a rectilinear motion. To prevent the telescopic portion 12 from interfering with the housing 11 in the rectilinear motion process of the pedestal 141, in the present invention, the telescopic portion 12 is enabled to ascend or descend conveniently in the rectilinear motion process of the pedestal 141 by disposing the damping portion 143 between the pedestal 141 and the telescopic portion 12 of the mouse device 1, thereby improving stability of reliability of the telescopic portion 12 when the telescopic portion 12 moves.

Referring to FIG. 2 and FIG. 5 again, the mouse device 1 further includes a control portion 15 that is located at a left side or a right side of the housing 11. The user may press the control portion 15 by using a thumb after the hand portion is placed at the housing 11, so as to adjust the volume of the telescopic portion 12 exposed outside the housing 11, until a palm of the user may be suitably attached to the mouse device 1. Although the control portion 15 shown in FIG. 2 and FIG. 5 is a mechanical touch-pressure component, and is disposed at the left side of the housing 11, it is not limited thereto. The control portion 15 may alternatively be an optical control component or a touch control component, and is disposed at another proper position of the housing 11.

In this preferred embodiment, the mouse device 1 further includes a processing unit 16 that may be a hardware component, a software component, or a firmware component, and is connected between the motor 13 and the control portion 15. When the user adjusts the volume of the telescopic portion 12 exposed outside the housing 11 by operating the control portion 15, the processing unit 16 may drive the motor 13 to provide a power required for moving the telescopic portion 12.

However, the foregoing is merely an embodiment, and a person skilled in the art may make any equivalent modification or design according to the actual application requirements. For example, to provide a stable power the telescopic portion, the mouse device may be modified and designed to use two motors and symmetrically dispose the two motors in the housing.

It may be learned from the foregoing descriptions that the mouse device 1 in the present invention may be used by the user to perform stepless control and fine adjustment to a position of the telescopic portion 12 by using the control portion 15. That is, the telescopic portion 12 may stay at any position, until the palm of the user is suitably attached to the mouse device 1. Moreover, in a movement process of the telescopic portion 12, an appearance of the mouse device 1 is kept flat without any gap. Therefore, a touch sense of the user for operating the mouse device 1 is not affected. Moreover, components within the mouse device 1 are also protected, so as to achieve waterproof, dust-proof, and anti-static effects. Therefore, the mouse device 1 has industrial value.

The foregoing is merely the preferred embodiments of the present invention, and is not intended to limit the scope of the present invention. Therefore, any other equivalent replacement or modification made without departing from the spirit disclosed by the present invention shall fall within the scope of the present invention.

What is claimed is:

1. A mouse device, comprising:
a housing, comprising a base and an upper cover, wherein the upper cover covers the base, and a through hole is formed between the upper cover and the base;
a telescopic portion, configured to support a hand portion of a user when at least a part of the telescopic portion is exposed outside the housing; and
a motor, disposed within the housing, and configured to provide a power to enable the telescopic portion to move outward or inward the housing through the through hole.

2. The mouse device according to claim 1, wherein the housing further comprises a sliding slot, and at least a part of the telescopic portion is embedded in the sliding slot; and when the motor provides a power, the telescopic portion slides along the sliding slot.

3. The mouse device according to claim 2, wherein the sliding slot is disposed at an inner side of the upper cover.

4. The mouse device according to claim 1, wherein the telescopic portion is nested by the housing.

5. The mouse device according to claim 1, further comprising a transmission module that is connected between the motor and the telescopic portion, and is configured to transmit the power provided by the motor to the telescopic portion.

6. The mouse device according to claim 5, wherein the transmission module comprises a pedestal and at least one guide screw rod; the telescopic portion is disposed on the pedestal; the at least one guide screw rod passes through the pedestal and is connected to the motor; and when the motor provides a power to the at least one guide screw rod, the pedestal moves along the at least one guide screw rod.

7. The mouse device according to claim 5, wherein the transmission module further comprises a damping portion that is disposed between the pedestal and the telescopic portion, and when the pedestal moves along the at least one guide screw rod, the telescopic portion ascends or descends in response to the damping portion.

8. The mouse device according to claim 1, further comprising a control portion that is used by the user to adjust a volume of the telescopic portion exposed outside the housing.

9. The mouse device according to claim 8, wherein the through hole is located at a rear side of the housing, and the control portion is located at a left side or a right side of the housing.

10. The mouse device according to claim 8, further comprising a processing unit that is connected between the motor and the control portion, wherein when the user adjusts the volume of the telescopic portion exposed outside the housing, the processing unit drives the motor to provide a power.
